(19) United States
(12) Patent Application Publication
(10) Pub. No.: US 2021/0178220 A1
(43) Pub. Date: Jun. 17, 2021

(54) INFLATABLE BASE FOR PHYSICAL THERAPY

(71) Applicant: Matthew Chase Carlisle, Carlock, IL (US)

(72) Inventor: Matthew Chase Carlisle, Carlock, IL (US)

(21) Appl. No.: 17/188,231

(22) Filed: Mar. 1, 2021

Related U.S. Application Data
(63) Continuation of application No. PCT/US2019/049116, filed on Aug. 30, 2019.
(60) Provisional application No. 62/726,243, filed on Sep. 1, 2018.

(51) Int. Cl. A63B 21/00

(52) U.S. Cl. CPC A63B 21/4037; A63B 2210/50; A63B 2209/00; A63B 2225/62

(57) ABSTRACT

A method of using a base for physical therapy is disclosed. The base includes a first major surface and a second major surface opposite the first major surface. A minor surface joins the first major surface to the second major surface, and the base has a deflated configuration at a first internal pressure and an inflated configuration at a second internal pressure that is greater than the first internal pressure. In the method, the second major surface of the base is positioned over a surface. The base is in the deflated configuration. Further, in the method, the base is inflated to the inflated configuration, and a physical therapy technique is performed on the base.

### CROSS-REFERENCE TO RELATED APPLICATIONS

This patent application is a continuation of International Application No. PCT/US2019/049116, filed Aug. 30, 2019, which claims the benefit of U.S. Provisional Application No. 62/726,243, filed Sep. 1, 2018, the entire teachings and disclosure of which are incorporated herein by reference thereto.

### FIELD OF THE INVENTION

This invention generally relates to the field of physical therapy and more particularly to a method of utilizing an inflatable base to perform physical therapy.

### BACKGROUND OF THE INVENTION

During a physical therapy session, a physical therapist will lead a patient through a variety of exercises and stretches designed to rehabilitate an injury or impairment. Such sessions are typically performed at a clinic or in the patient's home, but in either case the physical therapist often supplies all necessary equipment for properly performing the exercises and stretches.

Additionally, a physical therapist will typically assign the patient a variety of exercises and/or stretches (“movements”) to perform between sessions. These movements are not performed under the physical therapist's observation and without access to the physical therapist's equipment. Performing these movements speeds recovery, but the patient should be careful to perform them correctly, including from a well-supported position, in order to maximize the benefits and reduce the risk of injury. In this regard, patients with limited mobility will often perform their movements on an elevated surface, such as a bed or couch, so as to avoid having to drop down to and get up from the floor. However, the cushioning surface of the bed or couch may not provide adequate support or allow for proper alignment to effectively perform the movements.

As will be discussed herein, the inventor has recognized a need in the art for a base that can convert a variety of at-home surfaces into flat and stable exercise table while also being economical and easily storable for the user. These and other advantages of the invention, as well as additional inventive features, will be apparent from the description of the invention provided herein.

### BRIEF SUMMARY OF THE INVENTION

In an aspect, embodiments of a method of using a base for physical therapy are disclosed. The base includes a first major surface and a second major surface opposite the first major surface. A minor surface joins the first major surface to the second major surface, and the base has a deflated configuration at a first internal pressure and an inflated configuration at a second internal pressure that is greater than the first internal pressure. In the method, the second major surface of the base is positioned over a surface while the base is in the deflated configuration. Further, in the method, the base is inflated to the inflated configuration, and a physical therapy technique is performed on the base.

In the method, the surface may be an article of furniture, such as at least one of a bed, a couch, a chair, or a table. Further, in the method, the surface may be the ground. In embodiments, the base is inflated to a second internal pressure of from 10 to 15 psi.

In embodiments, the physical therapy technique is performed in at least one of a standing position, a supine position, a prone position, a hooklying position, a sidelying position, a kneeling position, a quadruped position, or a sitting position.

In embodiments, the first major surface has a width dimension and a length dimension in which the length dimension is perpendicular to the width dimension, and the length dimension is greater than the width dimension. For example, the length dimension may be from 65 to 85 inches, and the width dimension may be from 27 to 35 inches. Additionally, the base has a height dimension in the inflated configuration, which is the distance between the first major surface and the second major surface. In embodiments, the height dimension is from 1.5 to 5.0 inches.

In embodiments, the base is made from a drop stitch material. In certain embodiments, the drop stitch material includes a traction layer on the first major surface. Further, the traction layer may be ethylene-vinyl acetate.

In embodiments, the base includes one or more rings or straps, and the method further comprises anchoring the base to the surface using a tether connected to the one or more rings or straps. Additionally, in embodiments, performing of a physical therapy technique may involve connecting exercise equipment, such as resistance bands or foot straps, to the one or more rings or straps.

In embodiments of the method, a foam layer may be arranged over the first major surface prior to performing a physical therapy technique. In other embodiments, the foam layer may be integral with the first major surface.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view of an inflatable base for performing a physical therapy technique, according to an exemplary embodiment;

FIG. 2 is a top view of the base of FIG. 1, according to an exemplary embodiment;

FIG. 3 depicts the base being inflated by a pump, according to an exemplary embodiment;

FIG. 4 depicts a front perspective view of the base shown in FIGS. 1 and 2, according to an exemplary embodiment;

FIG. 5 depicts a cross-sectional view of an inflated drop-stitch material used to form the base, according to an exemplary embodiment;

FIG. 6 depicts the inflatable base positioned on a bed, according to an exemplary embodiment; and

FIG. 7 depicts a kit for inflating, storing, and transporting the inflatable base, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Various embodiments of an inflatable base for the performance of physical therapy techniques or yoga are disclosed herein. In general, the base may be described as a lightweight, portable, inflatable platform that transforms an item of furniture (e.g., a bed, a couch, a chair, etc.) into an exercise table comparable to the plinths used in a physical therapy clinic. As mentioned above, certain users may find it painful, difficult, or impossible to lie down or get up from the floor, and thus, the inflatable base disclosed herein allows for the conversion of an item of furniture into an elevated exercise platform. Additionally, because the base is inflatable/deflatable, the base can be deployed in a matter of minutes while also providing convenient storage. These and other aspects and advantages will be discussed herein in relation to the embodiments described below and shown in the figures. These embodiments of the inflatable base and associated method of performing physical therapy methods are provided by way of example and not by limitation.

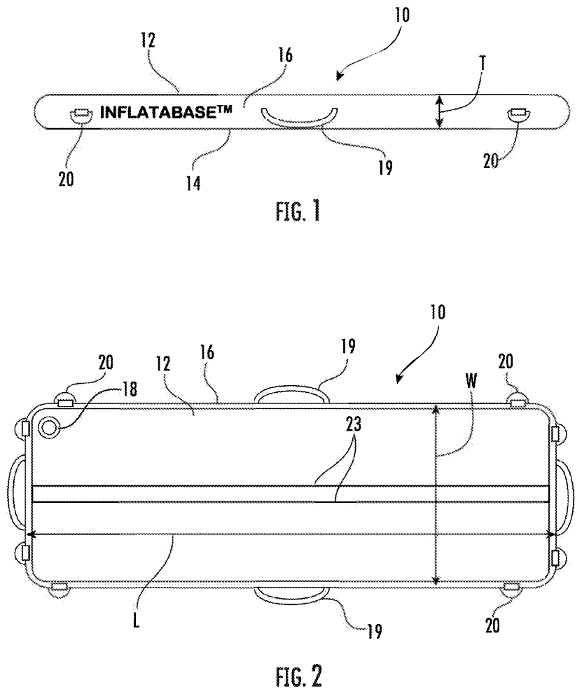

Referring first to the embodiment depicted in FIG. 1, a base 10 for performing physical therapy has a first major surface 12 and a second major surface 14. As can be seen in FIG. 1, the first major surface 12 and the second major surface 14 are joined by a minor surface 16 that extends between the first major surface 12 and the second major surface 14 and around the perimeter of the base 10. In embodiments, the first major surface 12 and the second major surface 14 define a thickness T of the base 10. In embodiments, the thickness T is from about 1.5 inches to about 5.0 inches, more particularly from about 2.0 inches to about 4.0 inches, and preferably from about 2.0 inches to about 3.5 inches. As will be discussed below, the base is thick enough to provide adequate support for performance of physical therapy techniques but also thin enough to be grasped easily for positioning.

FIG. 2 depicts a top view of the base 10, showing the first major surface 12. As can be seen in FIG. 2, the first major surface 12 of the base 10 defines a rounded rectangular shape, such that the base 10 overall is substantially cuboid. The first major surface has a width dimension W and a length dimension L. In the embodiment depicted, the width dimension W and the length dimension L are not equal. However, in other embodiments, the width dimension W and the length dimension L may be equal such that the first major surface 12 is a rounded square shape. In embodiments, the width dimension W is from 27 inches to 35 inches, more particularly from 27 inches to 32 inches, and preferably from 29 inches to 32 inches. In embodiments, the length dimension L is from 65 inches to 85 inches, more particularly from 70 inches to 80 inches, and preferably from 71 inches to 75 inches. In embodiments, the width dimension W and length dimension L are selected to replicate a plinth such as might be found in a physical therapy clinic. In other embodiments, e.g., for a chair or for a larger patient, the width dimension W and the length dimension L may be smaller or larger depending on the particular circumstances. In a particular embodiment designed for a chair or as a stability cushion on the floor, the width dimension W and the length dimension L of the base 10 are equal and are from 10 inches to 18 inches, more particularly about 15 inches (38 cm×38 cm).

As can be seen in FIG. 2, the first major surface 12 includes a valve port 18. The valve port 18 allows for the inflation and deflation of the base 10. In particular, the valve port 18 allows air to enter the interior of the base 10 in order for the base to inflate and air to exit from the interior of the base 10 in order for the base to deflate. While the valve port 18 is depicted on the first major surface 12, the valve port 18 may also be provided on the second major surface 14 or the minor surface 16. Additionally, the valve port 18 is depicted in a corner at one end of the first major surface 12, but the valve port 18 may be positioned substantially anywhere on the first major surface 12, the second major surface 14, or the minor surface 16.

Additionally, as can be seen in FIG. 2, the base 10 may include one or more handles 19 or rings 20, such as D-rings. The handles 19 allow for a person to position the base 10. Additionally, the handles 19, as well as the rings 20, allow a person to anchor the base 10 to the ground or to a piece of furniture. For example, a tether, such as a strap or bungee cord, may be attached to the handles 19 or the rings 20. The tether may be looped around the furniture, such as around a chair or mattress, to anchor the base 10, or the tether may be attached at the other end to a stake that can be driven into the ground to keep the base stable. Additionally, handles 19 or rings 20 may be used as attachment points for exercise equipment, such as resistance bands or foot straps. FIG. 2 also depicts center lines 23 running along the length of the base 10. The center lines 23 may be used to aid in alignment during the performance of various physical therapy techniques or yoga positions.

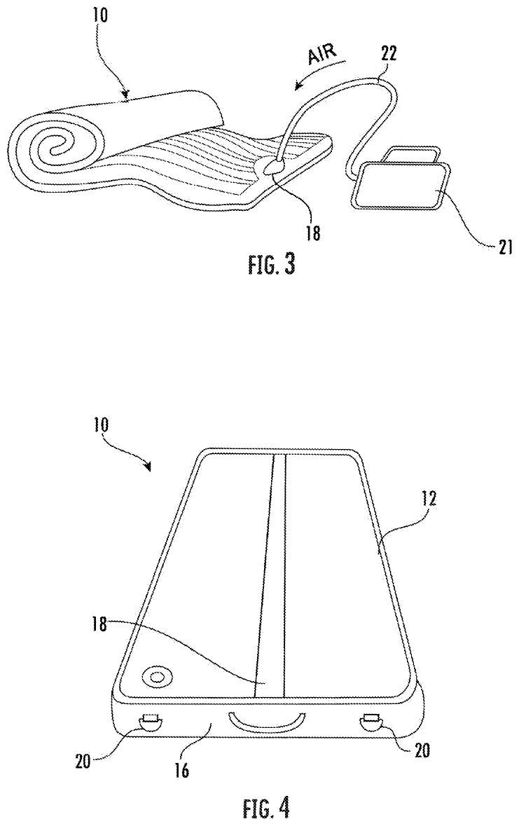

FIG. 3 depicts the base 10 being filled with air to transition from a deflated sate to an inflated state. As can be seen in FIG. 3, a pump 21 compresses air and forces it into the interior of the base 10. Specifically, the pump 21 includes a hose 22 that is connected at one end to the valve port 18. The pump 21 draws in surrounding air, compresses it, and forces it through the hose 22 into the base 10. FIG. 3 depicts an electrical pump 21, which may be powered by an AC or DC power supply (e.g., electrical plug, battery, solar panel, etc.). Further, in embodiments, the pump 21 may be a mechanical pump, comparable to a bike pump (as shown in FIG. 7). In FIG. 3, the base 10 is being inflated form a storage configuration in which the deflated base 10 is rolled-up along its length dimension. FIG. 4 depicts the fully-inflated base 10. In embodiments, the fully inflated base 10 is at a pressure of from 10 to 15 psi. It is believed that the base as described, including the above-described dimensions and internal pressure, are sufficient to support patients up to about 300 lbs.

Additionally, the base 10 can be inflated to less than the fully inflated configuration for performance of certain physical therapy techniques or yoga. For example, at a pressure less than the fully inflated pressure, the base 10 provides an unstable surface to practice balance activities. Further, the partially inflated base 10 can act as a crash pad for falls (for example, cushioning a fall from a bed in the night).

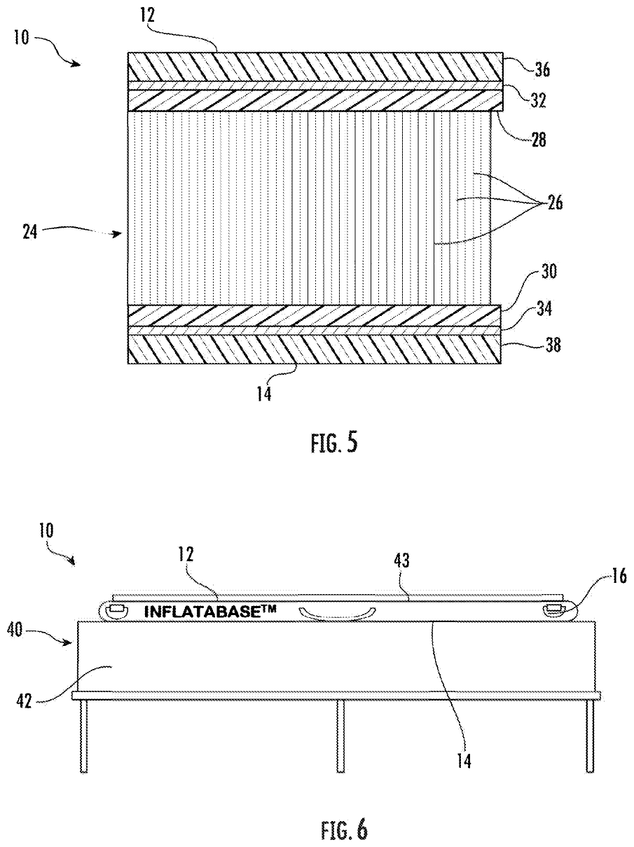

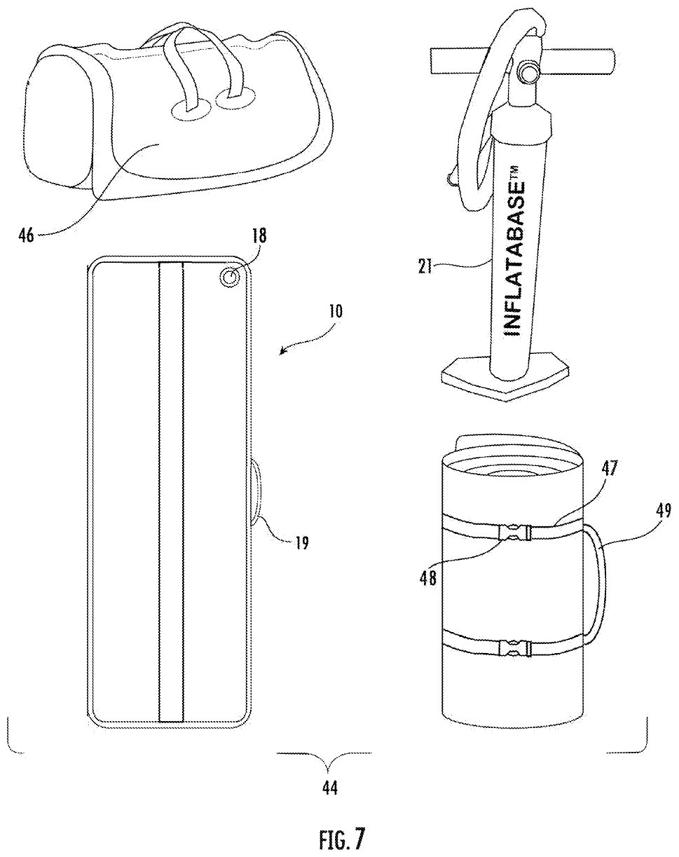

In embodiments, the base 10 is made of a drop-stitch material 24 as shown in FIG. 5. Drop-stitch material 24 allows structures to be inflated to high pressures by joining the first major surface 12 to the second major surface 14 by thousands of threads 26. In embodiments, the drop stitch material 24 includes a first woven support fabric 28 and a second woven support fabric 30 that are joined by the threads 26. In embodiments, the first woven support fabric 28 and the second woven support fabric 30 are a polyester, and the threads 26 are also a polyester. The polyester materials are used in embodiments because polyester is generally strong, durable and has very little stretch. In embodiments, the first woven support fabrics 28 is coated with a first air-tight layer 32, and the second woven support fabric 30 is coated with a second air-tight layer 34. In embodiments, the air-tight layers are PVC coatings. The drop-stitch material 30 further includes a first outer layer 36 that, in embodiments, defines the first major surface 12 and a second outer layer 38 that defines the second major surface 12. In embodiments, the first outer layer 36 and the second outer layer 38 are made of an ethylene-vinyl acetate (EVA) material. In embodiments, one or both of the outer layers 36, 38 may be textured to provide traction. Further, in embodiments, a foam layer (such as shown in FIG. 6) may be provided on the first outer layer 36. In embodiments, the foam layer may be a separate article that is placed over the first outer layer 38, or in other embodiments, the foam layer is integral with the first outer layer 38. In embodiments, the foam comprises one or more of EVA, polyurethane, neoprene, nitrile rubber, low density polyethylene, and silicone, among others.

In embodiments, the material of the minor surface 16 (not shown) includes a polyester base fabric with an air-tight PVC coating and optionally an outer layer of, e.g., EVA. In embodiments, the material of the minor surface is sewn or glued to the drop-stitch material in a manner that creates an airtight seam with the first major surface 12 and the second major surface 14.

As mentioned above, the inflatable base 10 is particularly suitable for performing physical therapy techniques, particularly when placed over a piece of furniture. FIG. 6 depicts the inflatable base 10 positioned on a piece of furniture 40, in particular a bed 42. Physical therapy patients, who may not be able to easily perform physical therapy movements on the floor or ground and who do not have access to a physical therapy plinth, often perform the physical therapy techniques on a bed, couch, or in a chair. Such surfaces typically do not provide the requisite support and flatness necessary to perform the techniques correctly. Accordingly, by placing the inflatable base 10 over the piece of furniture 40, a flat and rigid support surface is provided for performing the physical therapy techniques.

Additionally, in embodiments, the base 10 may be placed on the ground, and in this way, a flat, elevated surface may be provided on damp or lumpy ground. In an exemplary embodiment, the inflatable base 10 may be used to perform yoga outdoors.

In the method, the base 10 is positioned such that the second major surface 14 of the base 10 is over a surface, such as a mattress 42 as shown in FIG. 6. In embodiments, when the base 10 is positioned, the base 10 is in the deflated configuration. Then, in embodiments, the base 10 is inflated to the inflated configuration. Thereafter, a physical therapy technique can be performed on the base 10. The base 10 allows for a person performing the physical therapy technique to be in at least one of a standing position, a supine position, a prone position, a hooklying position, a sidelying position, a kneeling position, a quadruped position, or a sitting position, among others. Further, as shown in FIG. 6, the inflatable base 10 is provided with a foam layer 43 to provide additional comfort for a patient performing the physical therapy technique.

Advantageously, once the patient is finished performing the physical therapy technique, the base 10 can be deflated, rolled-up, and stowed in a compact package. FIG. 7 depicts an embodiment of an inflatable base kit 44. In an embodiment, the kit 44 includes the inflatable base 10, a pump 21, and a duffle bag 46. The base 10 can be rolled-up and stored in the duffle bag 46 along with the pump 21. In the embodiment shown in FIG. 7, the base 10 includes one valve port 18 and one handle 19, and the base 10 has the dimensions of 182 cm×81 cm×5 cm. In another embodiment, the kit 44 includes the base 10, the pump 21, and one or more straps 47 and clips 48 (e.g., side-squeeze style plastic buckles). In such an embodiment, the base 10 can be rolled-up and clipped in a storage position using the straps 47 and the clips 48. The straps 47 and clips 48 may be sewn, glued, or otherwise permanently secured onto the drop-stitch material of the base 10, or the straps 47 and clips 48 may be separate from the base 10 and wrapped around the base 10. In embodiments, the straps 47 are long enough to wrap around both the base 10 and the pump 21 to secure the pump 21 against the rolled-up base 10. Further, the straps 47 may also be provided with a handle 49 to facilitate carrying of the base 10 (and pump 21) without needing a duffle bag 46. Further, in embodiments, the inflatable base 10 may include Velcro straps and handles that allow the rolled up inflatable base 10 to be maintained in the rolled-up configuration while also providing a way to carry the base 10 without the use of the duffle bag 46. Accordingly, the inflatable base 10 is portable and stores in a small package size.

While the base 10 can be easily deflated to provide compact storage, the inflatable base 10 can also be stored in the inflated configuration, e.g., by propping against a wall or stored under a bed, because of its thinness and low weight that allow for easy manipulation.

The inventor believes that the inflatable base 10 can play an important role in patient compliance with home exercise programs by making available a space-saving and light weight clinic-quality plinth suitable for the patient's home. By improving patient compliance with home exercise plans, inflatable base 10 may support better clinical outcomes for patients. This in turn helps physical therapists/clinics improve their outcome scores, which can lead to increased reimbursement payments from insurance.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of using a base for physical therapy, the base comprising a first major surface and a second major surface opposite the first major surface, wherein a minor surface joins the first major surface to the second major surface and wherein the base has a deflated configuration at a first internal pressure and an inflated configuration at a second internal pressure that is greater than the first internal pressure, the method comprising the steps of:
positioning the second major surface of the base over a surface, the base being in the deflated configuration;
inflating the base to the inflated configuration; and
performing a physical therapy technique on the base.

2. The method of claim 1, wherein the surface is an article of furniture.

3. The method of claim 2, wherein the article of furniture includes at least one of a bed, a couch, a chair, or a table.

4. The method of claim 1, wherein the surface is the ground.

5. The method of claim 4, wherein the physical therapy technique is yoga.

6. The method of claim 1, wherein the second internal pressure is from 10 to 15 psi.

7. The method of claim 1, wherein the physical therapy technique is performed in at least one of a standing position, a supine position, a prone position, a hooklying position, a sidelying position, a kneeling position, a quadruped position, or a sitting position.

8. The method of claim 1, wherein the first major surface comprises a width dimension and a length dimension, the length dimension being perpendicular to the width dimension, and wherein the length dimension is greater than the width dimension.

9. The method of claim 8, wherein the length dimension is from 65 to 85 inches.

10. The method of claim 8, wherein the width dimension is from 27 to 35 inches.

11. The method of claim 1, wherein the base has a height dimension in the inflated configuration, the height dimension being a distance between the first major surface and the second major surface, and wherein the height dimension is from 1.5 to 5.0 inches.

12. The method of claim 1, wherein the base comprises a drop stitch material.

13. The method of claim 12, wherein the drop stitch material comprises a traction layer on the first major surface.

14. The method of claim 13, wherein the traction layer comprises ethylene-vinyl acetate.

15. The method of claim 1, wherein the base further comprises one or more rings or straps, and the method further comprises anchoring the base to the surface using a tether connected to the one or more rings or straps.

16. The method of claim 1, wherein the base further comprises one or more rings or straps and wherein the performing step further comprises connecting exercise equipment to the one or more rings or straps.

17. The method of claim 1, further comprising the step of arranging a foam layer over the first major surface prior to the step of performing.

18. The method of claim 1, wherein the base further comprises a foam layer integral with the first major surface.
